(19) United States
(12) Patent Application Publication
(10) Pub. No.: US 2007/0160449 A1
(43) Pub. Date: Jul. 12, 2007

(54) Robotic trailer loading/unloading system

(76) Inventors: Paramjit S. Girn, Lake Orion, MI (US); Brian A. Johnson, Rochester Hills, MI (US); Michael J. Turnbull, Rochester Hills, MI (US); Amit B. Kolhatkar, Rochester Hills, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/330,672

(22) Filed: Jan. 12, 2006

(51) Int. Cl. B65G 67/00

(52) U.S. Cl. 414/390

(57) ABSTRACT

A loading/unloading system for a trailer includes at least one loader/unloader positioned adjacent an opening of the trailer that incrementally removes material from the trailer. A material handling device is movable relative to the loader/unloader and transports material from the loader/unloader to a predetermined location within a manufacturing facility.

### FIELD OF THE INVENTION

The present invention relates to trailer loading/unloading systems, and more particularly to an improved trailer loading/unloading system for a manufacturing facility.

### BACKGROUND OF THE INVENTION

Conventional trailer loading/unloading systems are commonly used in manufacturing facilities to remove material from, or add material to, a trailer. Most manufacturing facilities typically include multiple docks to allow multiple trailers to access the facilities at the same time. A dock may require a dedicated trailer loading/unloading system to facilitate loading and unloading of multiple trailers at multiple docks at the same time.

FIG. 1 illustrates a conventional trailer loading/unloading system Q having a series of rollers R located on a dock U of a manufacturing facility V. When a truck trailer T is secured to the dock U of the manufacturing facility V, rollers S mounted in the truck trailer T move all of the material W from the truck trailer T and onto the rollers R of the manufacturing facility V. The material W engages the rollers R to temporarily position the material W on the dock U prior to distribution within the facility V. Because all of the material W located in the truck trailer T is removed at one time, there must be sufficient space in the manufacturing facility V to accommodate the cargo space of the truck trailer T (schematically shown as “X” in FIG. 1).

While conventional dedicated trailer loading/unloading systems adequately load and unload individual trailers, positioning a trailer loading/unloading system at each dock consumes manufacturing floor space. Furthermore, such conventional trailer loading/unloading systems require a space at least as large as a cargo space of the trailer to accommodate the material once removed from the trailer or staged to be loaded onto the trailer. In this manner, conventional trailer loading/unloading systems increase the operating costs of the manufacturing facility by requiring multiple systems and consuming manufacturing floor space.

### SUMMARY OF THE INVENTION

A loading/unloading system for a trailer according to a first object of the present invention is provided including at least one loader/unloader positioned adjacent an opening of the trailer that incrementally removes material from the trailer. A material handling device is movable relative to the loader/unloader and transports material from the loader/unloader to a predetermined location within a manufacturing facility.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a top schematic view of a manufacturing facility incorporating a conventional trailer unloading system according to an exemplary embodiment of the present invention;

FIG. 2 is a perspective view of a manufacturing facility incorporating a trailer unloading system in accordance with the principles of the present teachings according to an exemplary embodiment of the present invention; and

FIG. 3 is a top view of the manufacturing facility of FIG. 2 according to an exemplary embodiment of the present invention.

### DETAILED DESCRIPTION OF THE PREFERRED EMBODIMENTS

The following description is merely exemplary in nature and is in no way intended to limit the invention, its application, or uses.

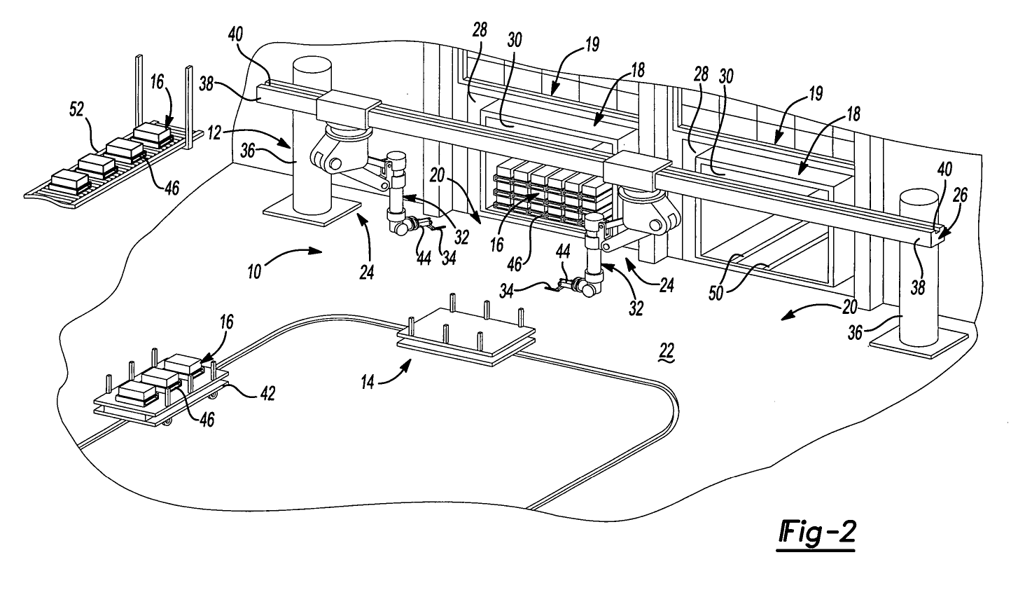

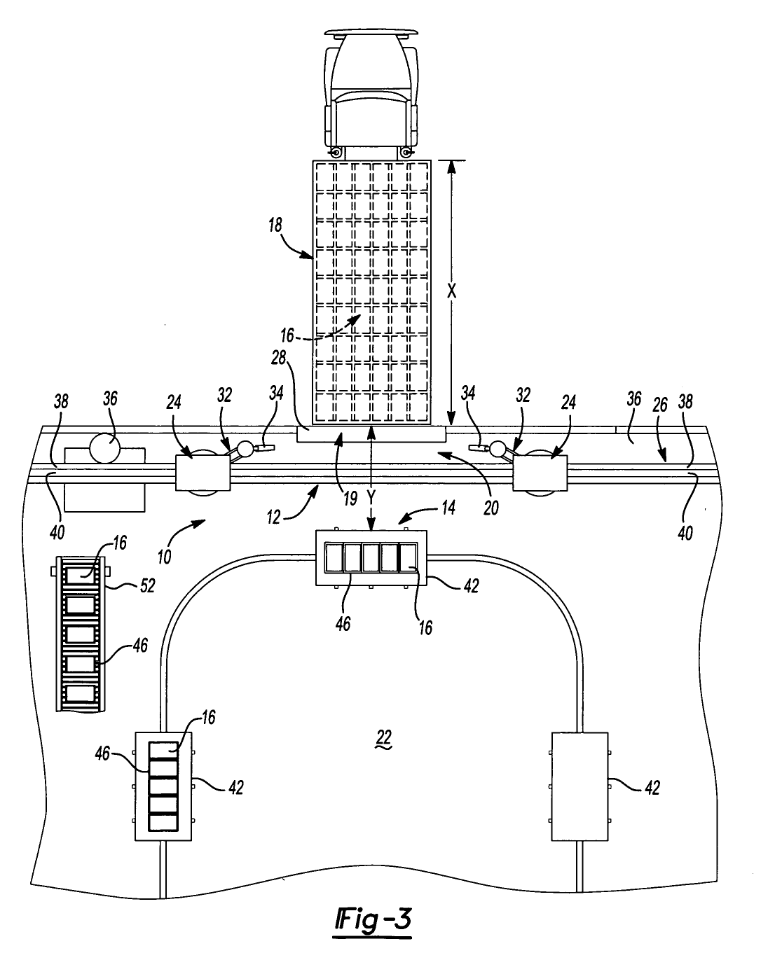

With reference to FIGS. 2 and 3, a trailer loading/unloading system 10 is provided and includes a loader/unloader assembly 12 and a material handling device 14. The loader/unloader assembly 12 cooperates with the material handling device 14 to remove material 16 from a trailer 18 positioned at a dock 20 of a manufacturing facility 22.

It should be understood that while a manufacturing facility 22 having a pair of docks 20 will be described hereinafter in the drawings, that the trailer loading/unloading system 10 could be used with a manufacturing facility 22 incorporating fewer or more docks 20 to accommodate fewer or more trailers 18. Furthermore, it should be understood while the trailer loading/unloading system 10 will be described hereinafter in the drawings as associated with an end-load trailer, that the trailer loading/unloading system 10 could equally be used with a flat-bed trailer, a side-unload trailer, a drop-deck trailer, a regular trailer, a facilitized trailer, or a non-facilitzed trailer.

The loader/unloader assembly 12 is positioned on the dock 20 of the manufacturing facility 22 and includes a pair or robots 24 supported by a gantry 26. The robots 24 are moveable along the gantry 26 generally parallel to an opening 28 of each dock 20 and therefore are also moveable in a direction generally parallel to an opening 30 of each trailer 18 (i.e., translational movement). Each robot 24 includes an arm 32 that controls movement of a gripper 34 located at a distal end thereof. The arm 32 moves the gripper 34 into and out of the trailer 18 to selectively remove a container such as a pallet 46 containing material 16 therefrom and is therefore rotatable relative to the gantry 26 (i.e., rotatable movement). In this manner, the arm 32 is able to move in a direction generally perpendicular to the opening 28 of each dock 20 as well as the opening 30 of each trailer 18.

It should be noted that material 16 may or may not be present on the pallets 46 depending on the application of loading or unloading. Furthermore, some materials 16 are not transported on a pallet 46. For materials 16 that do not require a pallet 46, the gripper 34 interacts directly with the material. 16 in place of the pallet 46 during unloading.

The gantry 26 is positioned adjacent each dock 20 and includes a pair of pedestals 36 and a track 38 extending generally between the pedestals 36. The track 38 includes a groove 40 disposed in a center channel thereof to control movement of the robots 24 generally between each pedestal 36. In this manner, cooperation between the groove 40 of track 38 and each robot 24 restricts movement of each robot 24 along the gantry 26 and in a direction generally parallel to the opening 28 of each dock and, thus, the opening 30 of each trailer 18.

It should be understood that, while a gantry 26 is disclosed, the robots 24 could alternately be rotatably mounted on a pedestal adjacent each dock opening 28 for movement relative to the opening 28 or could be mounted on a track disposed in a floor of the manufacturing facility 22.

The material handing device 14 is located on each dock 20 of the manufacturing facility 22 generally proximate to opening 28 to facilitate receiving material 16 contained on the pallets 46 from each robot 24. The material handling device 14 may include an automated guidance cart (AGC) 42 that is selectively driven to the docks 20 to pick up pallets 46 containing material 16 from each robot 24 and carry the pallets 46 to a predetermined location within the manufacturing facility 22. It should be understood that while an AGC is disclosed, that the material handling device 14 could alternately include an automated electrified monorail system or an overhead power and free conveyor 52. In any of the above configurations, the material handling device 14 is positioned proximate to the loader/unloader assembly 12 such that pallets 46 removed from each trailer 18 are easily placed on the material handling device 14 by the robots 24.

With particular reference to FIGS. 2 and 3, operation of the trailer loading/unloading system 10 will be described in detail. The trailer 18 is initially parked at the manufacturing facility near the dock 20 such that the opening 30 of the trailer 18 is aligned with the opening 28 of the dock 20. Once the trailer 18 is located relative to the opening 30 of the dock 20, the trailer 18 is locked in place to fix the relative position of the trailer 18 and dock 20.

Once in place, a dock door 19 covering the opening 28 of dock 20 is opened such that the robots 24 can freely access the opening 30 of the trailer 18. Once opened, access to the pallets 46 located within the trailer 18, and thus, the material 16, is permitted.

The robots 24 may be outfitted with a three-dimensional vision system 44 that allows the robot 24 to locate the material 16 positioned within the trailer 18. Once the robot 24 locates the material 16 on the pallets 46 within the trailer 18, software associated with the robot 24 causes the arm 32 to extend and the gripper 34 to contact at least one pallet 46 and remove the pallet 46 from the trailer 18.

Once the pallet 46 is removed from the trailer 18, the arm 32 moves the gripper 34, and thus, the pallet 46, away from, and through the opening 30 of the trailer 18. The robot 24 continues to move the pallet 46 away from the opening 30 of the trailer 18 until the pallet 46, and thus, the material 16 is positioned proximate to the material handling device 14.

Once the arm 32 has sufficiently moved the gripper 34 and, thus, the pallet 46 close to the material handling device 14, the arm 32 positions the gripper 34 such that the pallet 46 is positioned over an AGC 42. Following positioning of the material 16 over the AGC 42, the software directs the gripper 34 to release the pallet 46, thereby placing the pallet 46 and the material 16 on the AGC 42.

Once the pallet 46 is placed on the AGC 42, the AGC 42 leaves the dock 20 to deliver the material 16 to a predetermined location within the manufacturing facility 22. Following the departure of the AGC 42, another AGC 42 enters the dock 20 of the manufacturing facility 22 to receive material 16 from the robots 24.

The entering AGC 42 may include a pallet 46. The three-dimensional vision system 44 of the robots 24 locates the pallet 46 positioned on the AGC 42 and instructs the arm 32 to move the gripper 34 into engagement with the pallet 46. The gripper 34 engages the pallet 46 to remove the pallet from the AGC 42. The arm 32 then moves the gripper 34 and thus, the pallet 46, away from the AGC 42 and generally towards the opening 28 of the dock 20 and the opening 30 of the trailer 18.

Once the gripper 34 has sufficiently moved the pallet 46 away from the AGC 42, such that the gripper 34 and pallet 46 are positioned within the opening 30 of the trailer 18, the gripper 34 releases the pallet 46, thereby placing the pallet 46 within the trailer 18.

As described, the loader/unloader assembly 12 and material handling device 14 cooperate to remove pallets 46 from the trailer 18 and also to load pallets 46 from the material handling device 14 onto the trailer 18. As shown in FIG. 3, the AGC 42 is located a distance Y from the opening 28 of the dock 20 such that pallets 46 unloaded from the trailer 18 can be quickly and easily loaded onto the AGC 42 and pallets 46 can be quickly and easily loaded from the AGC 42 back onto the trailer 18.

Positioning the AGC 42 in close proximity to the opening 30 of the trailer 18 allows the loader/unloader assembly 12 to incrementally remove pallets 46 from the trailer 18. In this manner, the loader/unloader assembly 12 is able to remove only that material 16 which is required, rather than removing the entire contents of the trailer 18 at one time.

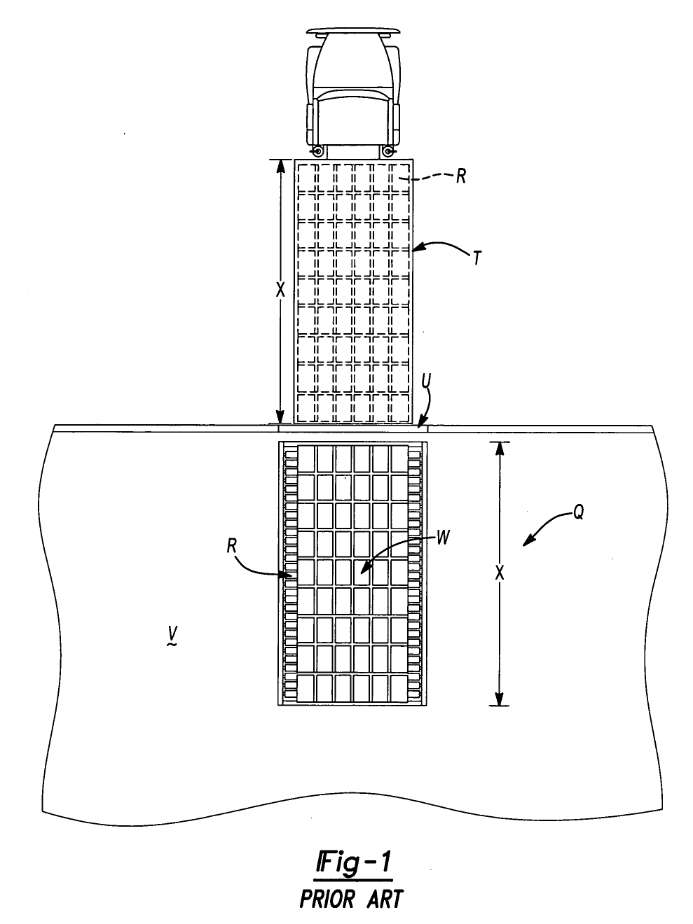

When comparing the trailer loading/unloading system 10 of the present teachings to the conventional system shown in FIG. 1, incrementally removing the material 16 from the trailer 18, rather than removing all of the material from the trailer at one time, reduces the amount of manufacturing floor space required by the trailer loading/unloading system. Specifically, the conventional system Q shown in FIG. 1 shows that the required floor space needed to unload the trailer T is generally equivalent to the entire cargo space of the trailer T, schematically represented by X (FIG. 1). Conversely, the trailer loading/unloading system 10 of the present teachings requires minimal floor space in the manufacturing facility 22. Specifically, the floor space required by the trailer loading/unloading system 10 is only that which is required by the robot 24 to extract material 16 from the trailer 18 and position the material 16 from the trailer 18 directly to an AGC 42. This distance is schematically represented Y in FIG. 3 and is basically defined by the reach of each robot 24.

The reach of each robot 24 can be minimized by including an indexing system 50 within each trailer 18 such that as material 16 is incrementally removed from the trailer 18, material 16 located in a front portion of the trailer 18 is indexed towards the opening 30 of the trailer 18. Once the material 16 is indexed towards the opening 30 of the trailer 18, the distance the robot 24 is required to reach into the trailer 18 to remove the material 16 is reduced. Therefore, the length of the arm 32, and thus the reach of the robot 24, can be minimized while still allowing the robot to remove material 16 from the trailer 18. Minimizing the reach of the robots 24 minimizes the distance Y that the opening 30 of the trailer 18 can be positioned from the AGC 42. Minimizing the distance the opening 30 of the trailer 18 is positioned from the AGC 42 saves manufacturing floor space and, thus, saves the manufacturing facility 22 money.

In addition to saving the manufacturing facility 22 money, the trailer loading/unloading system 10 also allows the manufacturing facility 22 flexibility in scheduling material 16 from each trailer 18. Specifically, material 16 can be removed from each trailer 18 and sequenced with each AGC 42 such that material 16 from each trailer 18 is only removed from the trailer 18 and positioned on the AGC 42 when required by the manufacturing facility 22.

The conventional system Q, as previously discussed, simply removes all of the material W from the trailer T at one time and positions the lot of the material W on the dock U of the manufacturing facility V. The trailer loading/unloading system 10 of the present teachings only removes that material 16 which was required by the manufacturing facility 22. Therefore, the material 16 can be removed from the trailer 18 in a sequence and timed with the material handling device 14 to deliver material 16 only when required by the manufacturing facility 22. As such, the trailer loading/unloading system 10 saves the manufacturing facility 22 money by not requiring a large amount of space at the dock 20 to store material 16 and provides the manufacturing facility 22 with the ability to sequence material 16 from the trailer 18 with a schedule of the manufacturing facility 22.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A loading/unloading system for a trailer comprising:
at least one loader/unloader positioned adjacent an opening of the trailer and operable to incrementally remove material from the trailer; and
a material handling device movable relative to said loader/unloader and operable to transport material from said loader/unloader to a predetermined location.

2. The loading/unloading system of claim 1, wherein said loader/unloader includes at least one robot.

3. The loading/unloading system of claim 2, wherein said at least one robot is operably attached to a gantry to guide movement of said at least one robot relative to said opening.

4. The loading/unloading system of claim 2, wherein said at least one robot is rotatably mounted to a pedestal adjacent to said opening for movement relative to said opening.

5. The loading/unloading system of claim 2, wherein said at least one robot is operably attached to a track to guide movement of said at least one robot relative to said opening.

6. The loading/unloading system of claim 2, wherein said at least one robot includes three-dimensional vision apparatus operable to locate said material on the trailer and/or to locate said material on said material handling device.

7. The loading/unloading system of claim 1, wherein said material handling device is an automated electric guidance cart.

8. The loading/unloading system of claim 1, wherein said material handling device includes a conveyor.

9. The loading/unloading system of claim 1, wherein said loader/unloader is moveable in a direction parallel to said opening and in a direction perpendicular to said opening.

10. The loading/unloading system of claim 1, wherein said loader/unloader is rotatable relative to said opening.

11. A method loading and unloading a trailer comprising:
positioning a trailer adjacent to a loading and unloading facility;
positioning a loader/unloader in the facility relative to an opening of said trailer;
removing a portion of a total amount of material from said trailer;
placing said removed material on a container of a material handling device; and
driving said material handling device to transport said material to a predetermined location within the facility.

12. The method of claim 11, wherein said positioning of said loader/unloader includes moving at least one robot about at least one of a gantry, a track, and a pedestal.

13. The method of claim 12, wherein said positioning of said robot includes at least one of translational and rotational movement.

14. The method of claim 11, further comprising removing containers from said material handling device.

15. The method of claim 14, further comprising placing said containers on said trailer.

16. The method of claim 11, further comprising using three-dimensional vision apparatus to locate said material on said trailer.

17. The method of claim 11, further comprising removing material from said trailer in a predetermined sequence.

18. The method of claim 17, further comprising timing said predetermined sequence with said material handling device.
